(19) United States
(12) Patent Application Publication
(10) Pub. No.: US 2024/0303760 A1
(43) Pub. Date: Sep. 12, 2024

(54) SYSTEM AND METHOD FOR AUTHORING AND EDITING CURRICULA AND COURSES AND ANALYSIS OF CURRICULA EFFECTIVENESS

(71) Applicant: Mathematics and Problem Solving LLC, South Portland, ME (US)

(72) Inventors: Albert Noyes, Falmouth, ME (US); Joanne Whitley, Marshville, NC (US)

(73) Assignee: Mathematics and Problem Solving LLC, South Portland, ME (US)

(21) Appl. No.: 18/668,104

(22) Filed: May 17, 2024

Related U.S. Application Data
(63) Continuation-in-part of application No. 17/226,978, filed on Apr. 9, 2021.
Application No. 17/226,978 is a continuation-in-part of application No. PCT/US2019/057105, filed on Oct. 19, 2019.
(60) Provisional application No. 62/747,741, filed on Oct. 19, 2018.

(51) Int. Cl. G06Q 50/20

(52) U.S. Cl. CPC G06Q 50/2053

(57) ABSTRACT

A computer-enabled system and related method to enable a user to edit, author and implement educational curricula and associated coursework. The system includes a content identification and parsing into instructional objects function, an instructional object organization function, a tool and template configuration function and a data gathering and analysis function. The instructional object organization function is configured to organize the instructional objects through metadata tags into a complete course content, wherein the organization of the instructional objects is modifiable.

### BACKGROUND OF THE INVENTION

### 1. Field of the Invention

The present invention relates to the development of curricula and courses used to educate students. More particularly, the present invention relates to a computer-based system configured to generate educational courses compliant with federal, state, and local curriculum and course requirements. The system enables its users to customize components of courses while remaining within requirement parameters.

### 2. Description of the Prior Art

Currently, school districts and teachers use textbooks that represent a “one size fits all” static model of educational material resources provided by traditional publishers. Teachers may also develop their own unique materials that replace or supplement the traditional materials. The current model is ill fitting, with gaps and superfluous content and inappropriate strategies. There is no assurance that materials comply with local and state curriculum requirements, and ongoing changes in priority and strategies make compliance less likely. They also often fail to account for the individual needs of students and teachers to maximize the learning process. The ad hoc teacher generated materials are difficult to produce, may be useful for a small set of students rather than of broader district-wide value and can be difficult to reproduce and implement on a large scale. Importantly, they may not address the instructional objectives and approaches that will be assessed on national, state and district tests. Further, the process of tailoring materials is time consuming and may not be a strong capability of the teacher. Nevertheless, teachers regularly feel the need to supplement or modify the educational materials that are available so as to best teach their students.

An important aspect of existing educational processes is the development of specific federal, state and district established curriculum and course requirements. Those requirements can be too blunt and broad to pinpoint and organize useful instruction and are often difficult to interpret. The text publishers build teaching content into their books that they feel best fit the broadest, “least common denominator” version of curriculum and course requirements implemented throughout the country. Teachers and school districts must then conform teaching methodology to comply with those one-size-fits-all textbooks or make their own adjustments while hoping to remain curriculum compliant. It is not surprising, then, that such a solidly embedded process ultimately places the needs of individual teachers, students, and small segments of the student population second to the broader standardized educational tools that have existed to date.

It should be recognized that existing curriculum and course implementation mechanisms are ill suited to the task of developing a valid, reliable, and sustainable analysis of what does and does not work. There are certainly standardized tests that are conducted to give a picture on a local, state, and federal scale to aid in determining student progress vis a vis standards, and local educational institutions and teachers use tests to ascertain what a student has learned. Unfortunately, that testing does not adequately inform educators as to the best practices for improving that comprehension and there are insufficient data to show at a more granular level what particular course content and organization leads to the best comprehension outcomes. A much better understanding of what instructional practices and materials can ultimately lead to better student comprehension and better usage of a teacher's time is highly desired.

What is needed is a system and method that are configured to break the one-size-fits-all model of curriculum and course materials implementation. Further, what is needed is such a system and method that can be readily implemented and adjusted as desired to produce curricula and course content that is compliant with federal, state and district educational requirements. What is also needed is such a system that can be easily accessed and is configured for revision and supplementation by teachers and curriculum coordinators within the above requirements. Yet further, what is needed is a system and method that can be used to identify best curriculum and course materials implementation. The system and method should be available electronically so that school districts, teachers and students are not bound solely to textbooks that are of a fixed nature. In short, it is important to give curriculum leaders and teachers across the US and around the world the ability to teach as they see fit, and then correlate their approaches to identify what works best for student improvement. We can then feed that information back to educators, researchers, publishers, and consultants, and inform and improve their classroom practices.

### SUMMARY OF THE INVENTION

It is an object of the invention to provide a system and method that can be readily implemented and adjusted as desired to produce curricula and course content that is compliant with federal, state and district educational requirements. It is also an object of the invention to provide such a system that can be easily accessed and is configured for supplementation by teachers and curriculum coordinators. Further, the system and method of the present invention are available electronically so that school districts, teachers and students are not bound solely to textbooks that are of a fixed nature. The electronic implementation of the present system and method enables the gathering of data that can be used to identify best curriculum, pedagogical and course material practices.

The present invention is a curriculum engine established as a computer-implemented software program. It gives school districts the tools and resources they need to edit and enhance instructional resources to suit their needs, and address instructional priorities, on an unlimited basis. The underlying data and rules ensure alignment and fidelity to curriculum guidelines.

The invention is a “curriculum-as-a-service” program that enables users to edit and author curriculum and courses. It facilitates analysis of the correlation between instruction and learning outcomes. It contains “prepopulated” instructional objects and courses that can be augmented with free online resources, district-built and district-owned resources.

The system and related method was initially implemented by unpacking existing standards intentionally and granularly to identify the underlying course content skills, contexts, forms, and features that then identify discrete learning objectives and sequences. The system can be used to implement any course content including, but not limited to the primary courses such as mathematics and English but not limited thereto. This allows courses to be designed with a laser focus on customized, aligned, and personalized student learning while also embedding and supporting effective teaching practices, all in the context of state and district instructional objectives.

The system has three primary components:
1) Instructional Object Repository, which is both prepopulated and that is configured to grow dynamically as users add and approve resources;
2) An analytical engine; and
3) Wizards, rules, tools, and templates

The instructional object repository provides access to instructional objects (tasks, lectures, activities, etc.) that represent an array of educational content including content provided by a system administrator considered to be effective course material, free content available through the internet, and content that the school district client, such as a curriculum coordinator or a teacher, for example, owns and/or authors. The analytical engine can be used to track what is being used within a district or across districts and compares that information to ongoing assessment results to evaluate the effectiveness of the instructional content and strategies chosen by districts and teachers and identifies gaps in resultant outcomes that can be used by the user to implement changes in the course materials. The wizards, rules, tools, and templates enable course and lesson sequencing and organization, tools to assist in building and organizing courses, lessons and components, and guides for editing and enhancing course content and implementation to maintain fidelity to curriculum requirements, prerequisites, depth of knowledge and other educational interests.

The system is established in one or more computer programs that may be implemented on one or more computing devices that include, but are not limited to, mainframe computers, desktop computers, tablets, and mobile devices such as smart phones, for example. The one or more computer programs are arranged to improve the function of the one or more computing devices by making relevant information collection, evaluation, and dissemination more efficient and easier for users to enable. The one or more computer programs may be referred to herein collectively as the computer program and the one or more computing devices may be referred to herein collectively as the computing device. The computer program may be accessed through a computing device.

The computer programs are established in software that embody functions carried out through the computing device onto which the application is loaded. The software provides the primary functions of: 1) content identification and parsing into instructional objects; 2) instructional object scrubbing and organization; 3) tool and template configuration; 4) data gathering and analysis. The software is generated using application generation tools known to those skilled in the art of producing such programs. For example, the program may be developed by generating computer instructions embodying the functions described using an iOS tool or such other tools as are suitable for generating and modifying a user interface, data gathering and storing, data integration and access, and bug fixing. The advantages of the present invention are enabled by the functionality of the applications described herein and in the accompanying figures.

The system of the present invention uses curriculum objects and a standards-based platform for editing and authoring to empower school districts to take control over their curriculum and analyze what works within and across school systems. If the system of the present invention had no curriculum objects, each school system would use its own content. In that situation, which is the current situation in school systems that do not employ the current invention, comparisons of the effectiveness of course curricula would not be possible and analysis of what does and does not work would not be possible. If the platform embodying the present invention did not enforce compliance with state standards and local priorities, then teachers could teach anything and there would be no rubric that made any sense. The present invention eliminates that variability. Instead, the invention makes it possible to compare instructional content, strategies, and sequences within and across school systems against a common goal, state assessments and see “what works.”

The invention is a computer-implemented system configured to improve the operation of a computing device to enable a user in a school district to edit, author, and implement educational curricula and associated coursework that are compliant with government-established course curricula standards, such as state and local government standards but not limited thereto. The system includes a computing device arranged for access to the internet and having stored thereon computer-executable instructions configured to cause the computer device to implement instructions. It also includes an instructional object repository accessible through the computing device, wherein content, vetted and enhanced with specific-purpose meta data as described herein, of the instructional object repository includes instructional objects. The system also includes an instructional object organization function configured to associate the instructional objects in the instructional object repository with metadata arranged to enable access of particular instructional objects and compile those selected instructional objects into the courses that include the associated coursework, wherein the courses may be modified by changing course specifications consistent with defined course standards and parameters, which result in changes in the organization of the instructional objects applied to those modified courses.

The system further includes a tool and template configuration function configured to enable a user to generate sequences of delivery of the instructional objects of the instructional object repository that align with the government-established course curricula standards for the courses, including but not limited to sequencing, particularly for courses requiring the completion of prerequisites, wherein the tool and template function is further configured to enable a user to modify instructional components of the courses only to the extent that such modified instructional components do not deviate from the government-established course curricula standards. For purposes of the invention, modifying includes, but is not limited to, removing them, replacing them, swapping them, reordering them, etc.

The tool and template configuration function is also configured to alert the user when one when or more instructional components of a recommended course curriculum are included or not included in a way that fails to align the course with the government-established course curricula standards. The system further includes an analytical engine configured to track and evaluate instructional content used in a school district to identify gaps in resultant outcomes used to implement changes in course materials.

The invention as described carries out two primary functions: 1) it empowers schools to quickly and effectively generate course curricula that they know will be standards compliant; and 2) establishes guardrails with respect to any course changes the teacher or school may wish to implement in a class, wherein the guardrails ensure that any such variations can only be used if standards compliance remains in effect. With these functions in place, data gathered from generated curricula can be used to gather information comparing like course work student outcomes within a school system and across school systems.

That “big data” enables a school system to discover “what works” in terms of teaching mechanisms and content, all of which aids a teacher to teach individual students as they need, and an entire class as it needs. As for what constitutes “what works,” assessments, such as state and local assessments, but not limited thereto, define outcomes of proficiencies for specific courses. That information may then be learned to recommend and refine generated course curricula to enhance outcomes further for individual students and classroom-wide. This capability is a substantial improvement over current systems of education, which have previously allowed course object selection without restrictions that ensure any course deviation causes the class to fall outside of standards and therefore cannot gather information to ascertain what works. In addition, using one size fits all curricula does not facilitate experimentation and variation which can reveal nonobvious and novel information about how to improve student performance. The invention allows for course object variations but only to the extent the course remains within the standards guardrails. The same concept of guardrails also applies to proposed variations in course sequencing when course sequencing is of importance, such as when prerequisites must be met, for example.

In an embodiment of the invention, the system includes a predictive analytic function, which enables the introduction of proactive, student-specific recommendations to teachers on a regular basis. This function integrates current and historical data from a Student Information System (SIS), assessments from multiple sources including the school and the state, demographic data, and any other information that could be useful. This functionality is implemented in one or more of AWS Machine Learning, AWS SageMaker, and AWS Forecast. The predictive analytic function further provides teachers with contextual information about why any particular prediction has been made. For example, it can be employed for students that are struggling and need more help or for students who are more advanced and need additional work to retain their interest in the topic.

In one example, the function is configured to predict that certain students are going to struggle with the unit to be covered in the coming week. The notification would include information about the specific students, details as to why each one was flagged as having the potential to struggle, and student-specific suggestions for additional homework assignments. In a second example, the function is configured to predict which students will struggle with one or more topics at the start of the school year and then provide the same information as in the first example, but further includes additional suggestions about what sort of learning environments or tools work well for each student, how they have responded in the past, and specific subject areas where they may need additional support, as well as what that support might be. This may be added to the work the student is assigned with a simple approval from the teacher (or modifications as desired). In a third example, the function is configured to “look” at progress relative to the topics that need to be covered for a state assessment, warn the teacher that there is an upcoming assessment on a certain date and that at the current pace they won't cover all of the relevant topics before the assessment, and suggest which topics could be removed to bring the schedule back in line. In effect, the predictive analytic function gathers information from the analytical engine described and, in effect, performs as an assistant to the teacher who is fully aware of the state of the current class and all of the students as well as anything relevant, such as state assessment schedules. While others are “a priori” analyses, this function of the invention is based upon actual evidence and continually learns; that is, it is empirical.

### BRIEF DESCRIPTION OF THE DRAWINGS

FIG. 1 is a simplified representation of the curriculum and course material system of the present invention.

FIG. 2 is a simplified representation of primary components of the system.

FIG. 3 is a simplified representation of the logical configuration of the system.

FIG. 4 is a simplified representation of the interaction between users and content input options through the system.

FIG. 5 is a simplified representation of a screen capture of a first user interface display of the system.

FIG. 6 is a screen capture of a second user interface display for choosing objects associated with a course implementation activity.

FIG. 7 is a screen capture of a third user interface display.

FIG. 8 is a screen capture of a fourth user interface display.

FIG. 9 is a simplified representation of a fifth user interface display.

FIG. 10 is a screen capture of a sixth user interface display.

FIG. 11 is a screen capture of a seventh user interface display.

FIG. 12 is a screen capture of an eighth user interface display.

FIG. 13 is a screen capture of a ninth user interface display.

FIG. 14 is a screen capture of a tenth user interface display.

FIG. 15 is a simplified representation of an eleventh user interface display.

FIG. 16 is a screen capture of a twelfth user interface display.

FIG. 17 is a screen capture of a thirteenth user interface display.

FIG. 18 is a screen capture of a fourteenth user interface display.

### DETAILED DESCRIPTION OF THE INVENTION

The present invention is a system and method configured to enable users to author and implement educational curricula and associated coursework. The system of the present invention comprises a set of functions described herein embodied in a computing system programmed to perform functional steps associated with the method described herein. The computing system may be associated with local or remote computing means, such as one or more central computers, such as server in a local area network, a metropolitan area network, a wide area network, or through intranet and internet connections.

The computer system may include one or more discrete computer processor devices. Examples of known computing devices that may be suitable for use with the invention include, but are not limited to, personal computers, server computers, hand-held or laptop devices, cellular phones including smart phones, multiprocessor systems, microprocessor-based systems, set top boxes, programmable consumer electronics, network PCs, minicomputers, mainframe computers, distributed computing environments that include any of the above systems or devices, and the like. The computer system may include computer devices operated by one or more users, such as through a desktop, laptop, or servers, and/or one or more providers of services corresponding to one or more functions of the invention.

The server, the computer processor, or a combination of both may be programmed to include one or more of the functions of the invention system. One or more relational databases that may be associated with the server, the computer processor, other computing devices, or any combination thereof, include information related to the use of the invention system. For example, the database includes information associated with a plurality of objects in the form of interactive worksheets and assessments, PDFs, PPTs, videos, but not limited thereto. The relational database of the present invention is used for gathering, storing and making accessible the objects and other information. For the purpose of the description of the present invention, a database is a collection of stored data that are logically related. Although there are different types of databases, and the database of the present invention may be any of such types, it is preferably a relational database with a relational database management system, comprising tables made up of rows and columns. Data stored in the relational tables are accessed or updated using database queries submitted to the database system. The database may be populated and updated with information provided by an application provider capable of carrying out one or more of the steps associated with the system of the invention, one or more course curricula originators, one or more teachers, or any other educational content stakeholders.

The invention may be described in the general context of computer-executable instructions, such as program modules, being executed by a computer. Generally, program modules include routines, programs, objects, components, data structures, etc. that perform particular tasks or implement particular abstract data types. As indicated above, the system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices. Storage of program instructions and database content may thereby be cloud-based as they can be stored on remote servers and accessed through internet-based connections.

The computer processor and interactive drives, memory storage devices, databases and peripherals may be interconnected through one or more computer system buses. The system buses may be any of several types of bus structures including a memory bus or memory controller, a peripheral bus, and a local bus using any of a variety of bus architectures. Computer system 100 typically includes a variety of computer readable media. Computer readable media can be any available media that can be accessed by the computer system and includes both volatile and non-volatile media, removable and non-removable media. By way of example, and not limitation, computer readable media may comprise computer storage media and communication media. Computer storage media includes volatile and non-volatile, removable, and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system. The computer system further includes computer storage media in the form of volatile and/or non-volatile memory such as Read Only Memory (ROM) and Random Access memory (RAM). RAM typically contains data and/or program modules that are accessible to and/or operated on by the computer processor. That is, RAM may include application programs, such as the functional modules of the system of the present invention, and information in the form of data. The computer system may also include other removable/non-removable, volatile/non-volatile computer storage and access media. For example, the computer system may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processor. A user may enter commands and information into the computer processor through input devices such as a keyboard, a touchpad, or a pointing device such as a mouse. Other input devices may include a microphone, joystick, game pad, satellite dish, scanner, or the like. These and other input devices are connected to the computer processor through the system bus, or other bus structures, such as a parallel port, game port or a universal serial bus (USB), but is not limited thereto. A monitor or other type of display device is also connected to the computer processor through the system bus or other bus arrangement.

The computer processor may be configured and arranged to perform the described functions and steps embodied in computer instructions stored and accessed in any one or more of the manners described. The functions and steps, such as the functions and steps of the present invention described herein, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processor, instruct the computer processor to perform one or more processes or acts described herein, and/or various examples, variations and combinations thereof Such instructions may be written in any of a plurality of programming languages, for example, XML, Java, Visual Basic, C, or C++, and the like, or any of a variety of combinations thereof. The computer-readable medium on which such instructions are stored may reside on one or more of the components described above and may be distributed across one or more such components.

Access is granted to the curriculum development and implementation system upon completion of authentication procedures associated with the platform used to present a user interface for interaction by a user with the objects database. Access to the objects database of the present invention is made through authentication steps of the type generally known including, but not limited to, providing a user name and a password, for example.

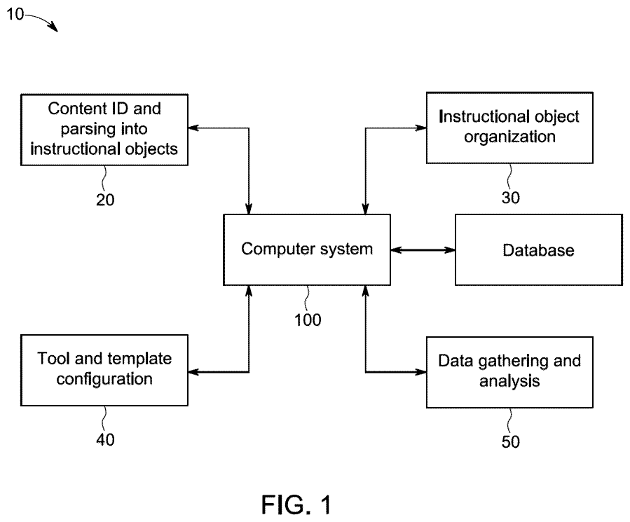

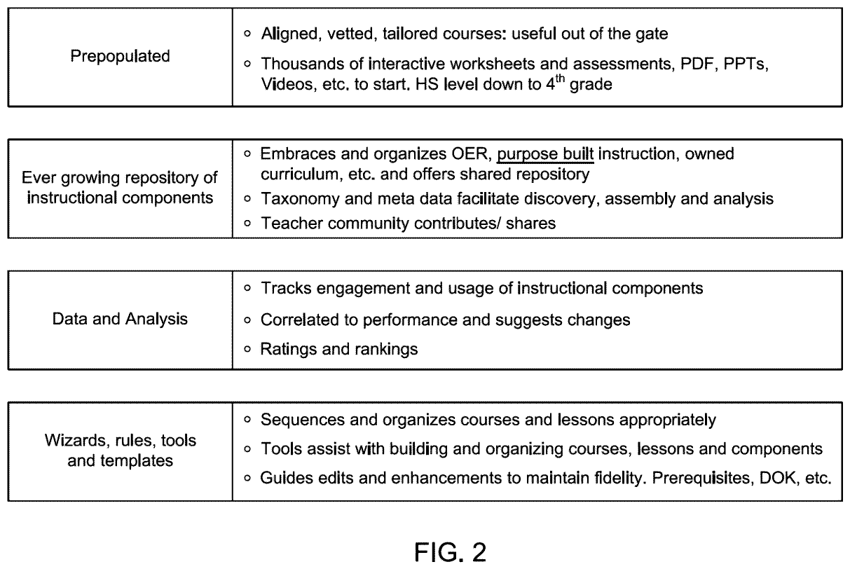

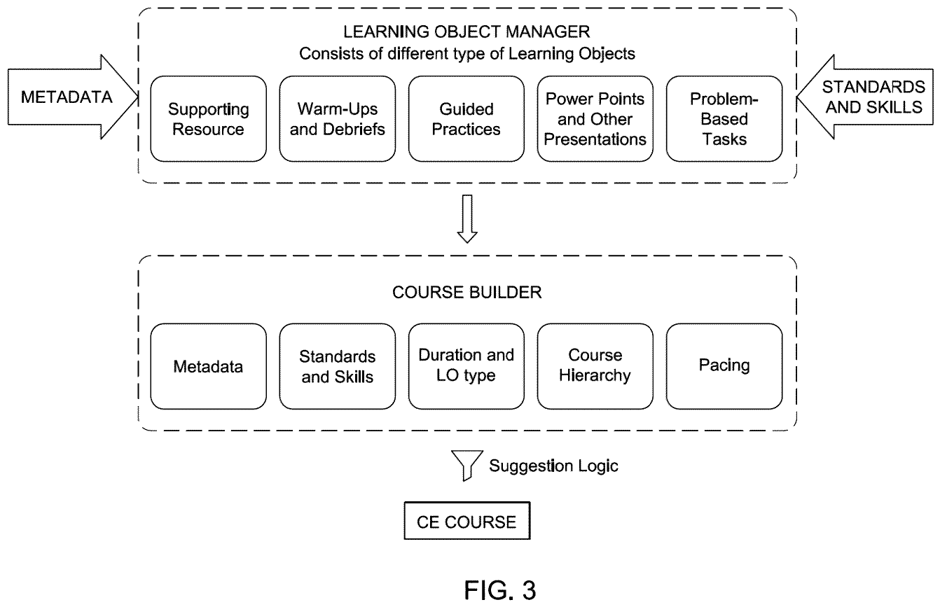

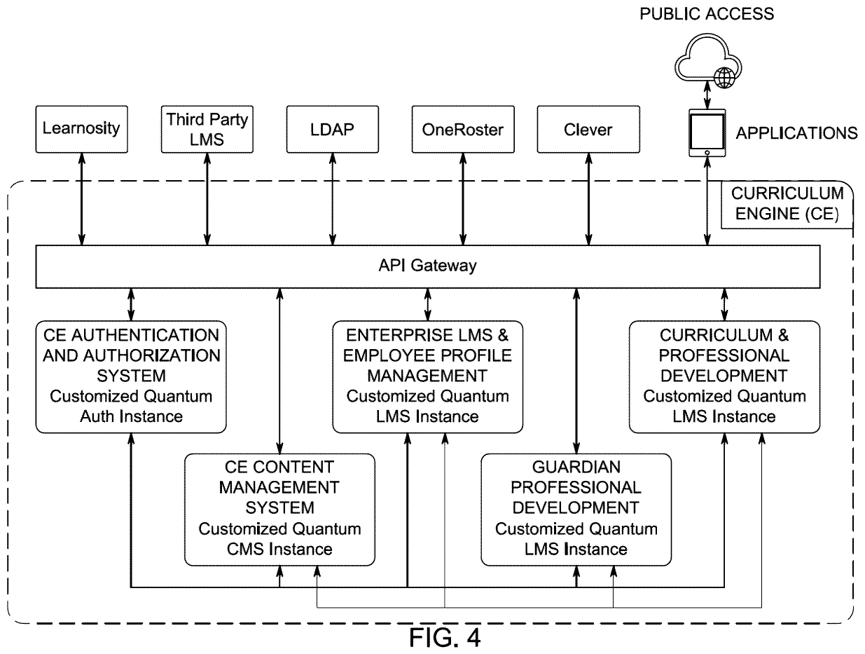

As represented in FIGS. 1-4, a system 10 to author and implement educational curricula and associated coursework includes a set of functions that can be accessed through the computer system, either in a storage device such as a CD, or from a remote location through the internet. The system 10 includes a content identification and parsing into instructional objects function 20, an instructional object organization function 30, a tool and template configuration function 40 and a data gathering and analysis function 50. The functions described herein enable a user to produce one or more course programs with complete teaching and testing capability that are in compliance with standards defined by one or more of federal, state and district guidelines. The system 10 and its functions are arranged to enable a curriculum coordinator and/or a teacher to choose instructional objects of interest that are prepopulated in the system 10, to choose additional instructional objects of interest, and/or to develop customized instructional objects. Guidance is provided to ensure that instructional objects chosen or developed remain in compliance with district guidelines.

The content identification and parsing into instructional objects function 20 is configured to gather information about educational standards requirements, content of course materials that are available directed to one or more subject matter areas of interest including, but not limited to, mathematics. The course materials may be of any format and type of interest including printed text, test questions, videos, Powerpoint presentations, graphics, and any other sort of material that the developer, district, teacher, or other stakeholder deems to be of value in teaching students about the subject matter. This ability to gather course material content from any source frees the educator from being limited to the set of published textbooks that had historically been used to teach prior to implementation of the present invention. The gathered content is stored in the computer system 100 in a format that enables its selection and isolation.

The content gathering and parsing into instructional objects function 20 is further configured to parse and scrub the gathered content into individual instructional objects that form the basis of the educational mechanism enabled by the system 10. That parsing involves isolating elements of the gathered content into components that can be moved where desired into a course program and scrubbed to remove selectable surrounding material of the original source.

The instructional object organization function 30 is configured to operate on the instructional objects contained in the database to develop editable course content. Individual instructional objects are associated with metadata that allows for easy access to relevant instructional objects used to compile courses of selectable configuration, wherein metadata choices made determine which instructional objects are used to create a particular course. Tethering the instructional objects to courses through metadata further enables course editing in addition to course building. Examples of metadata options of the system 10 include, but are not limited to, standards and skills embodied in each instructional object, depth of knowledge, time expected to take to complete a lesson, how difficult the lesson is, and what medium it is from, e.g., pdf, link, district created (that is, the origin of the instructional object). Other types of metadata may be employed to provide further granularity to the course building. Once metadata choices have been made, course content is populated with applicable instructional objects. Use of the system 10 enables user access to the instructional object organization function 30.

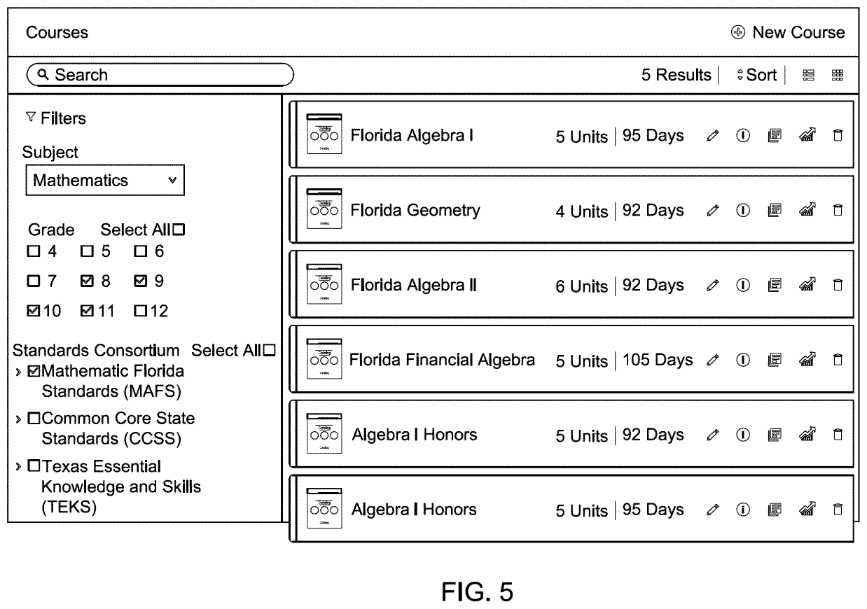

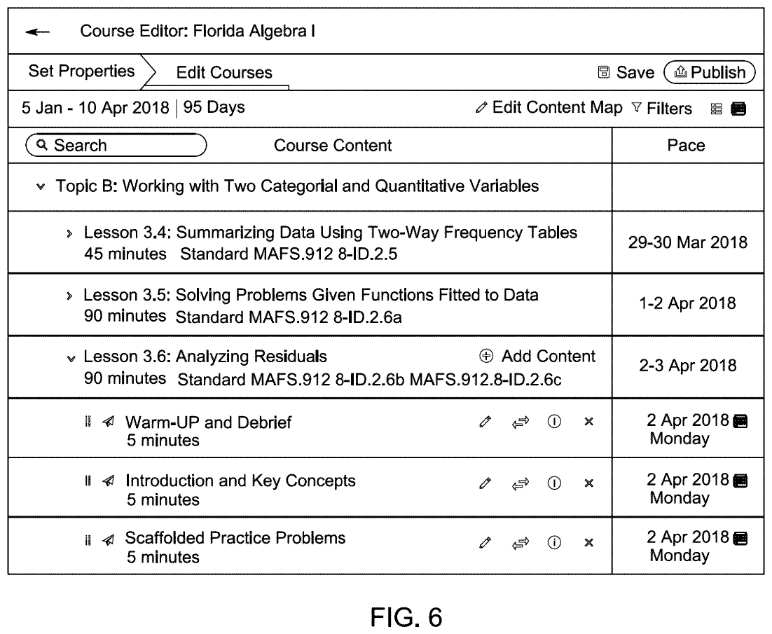

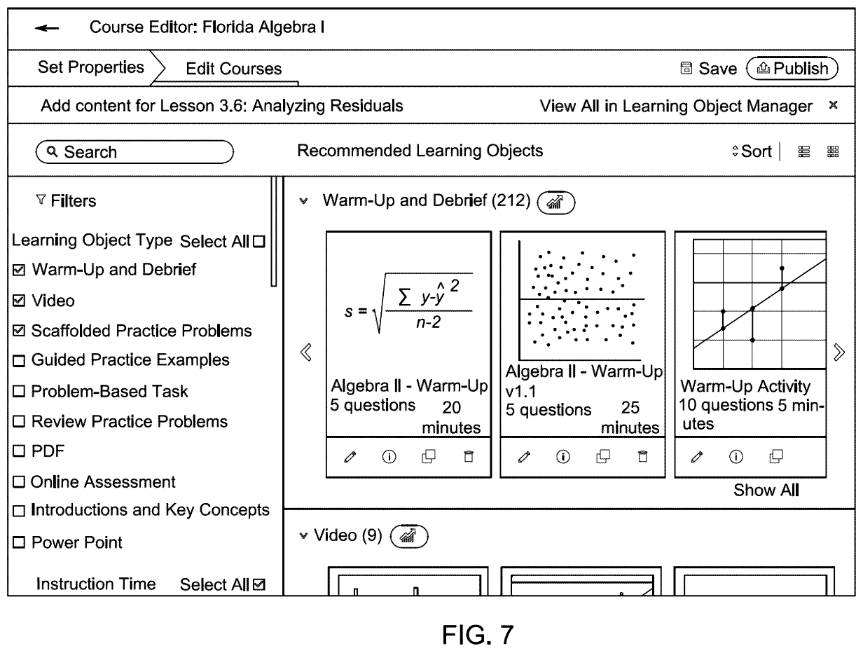

The tool and template configuration function 40 is configured to enable the user of the system 10 to generate sequences of instructional object delivery and to organize course and lessons as desired. That may begin with a ready-to-use course construct that aligns with an approved course curriculum. See, for example, FIG. 5. It is further configured to allow the user to customize course building through additional metadata configuring. The tool and template configuration function 40 is further arranged to ensure that any modifications to an automatically developed course configuration remains compliant with defined standards and parameters when course content is modified, removed, or enhanced. That is, the user may “drill down” on the content of individual selected course content and see daily instruction guides, edit, remove, or replace various instructional components. However, the tool and template configuration function 40 is arranged to alert the user when any such changes fail to align to approved curricula, including use of instructional objects out of an approved sequence. See, for example, FIG. 6. Nevertheless, assuming modifications are compliant or are not overridden in some manner, a user may choose from instructional objects that may be prepopulated from the system originator, content modified into instructional objects that the educator supplies, or content modified into instructional objects that an individual teacher provides. See, for example, FIG. 7.

Whereas the delivery of instructional objects to students through one or more generated course material sets occurs through the computer system 100, it is possible to gather information about the impact of course content implementation. Under the current broad implementation of course content delivery that is largely manual and static, there is limited capability to gather information indicative of the effectiveness of course content. That may occur pursuant to isolated studies that occur in individual states, districts and classrooms, The data gathering and analysis function 50 is configured to gather data in individual districts as well as across all users who access the system 10 to determine at least generated course curricula that are used, specific instructional objects that are used, and the outcomes of subject matter comprehension testing that is accomplished through, for example, gathering instructional objects in the form of homework, quizzes and tests. Data of interest may be accessed through metadata tags as well. That is, the data gathered through access to instructional objects is populated into the database and associated with relevant metadata so as to tether applicable data to courses that generate that data. Outcomes may then be analyzed.

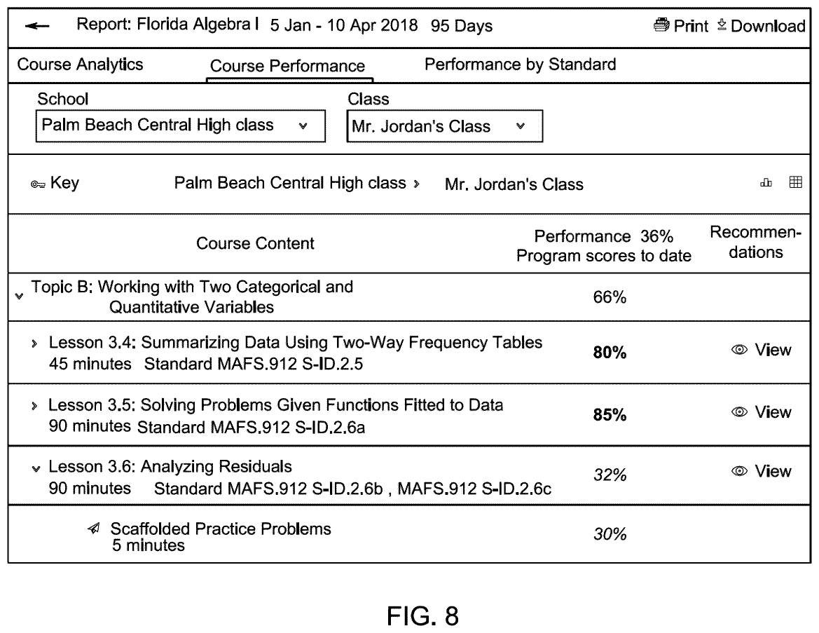

That data can be analyzed in any number of ways using the data gathering and analysis function 50 to provide insight into the effectiveness of any part of the instructional process embodied in the system 10. An example of a local analysis of the effectiveness of the use of certain instructional objects in a course is shown in FIG. 8. It is to be understood that with the ability to capture all manner of data using the system 10, the present invention can be used to pinpoint best practices and convey that information to all users. Teachers and districts are no longer isolated with respect to what may work best for their students. The data may be parsed to the point that a teacher can determine whether certain types of students may be more receptive to certain types of instructional objects than others so that the classroom, whether in person or remote, can be used to maximal effect to educate as many students as possible.

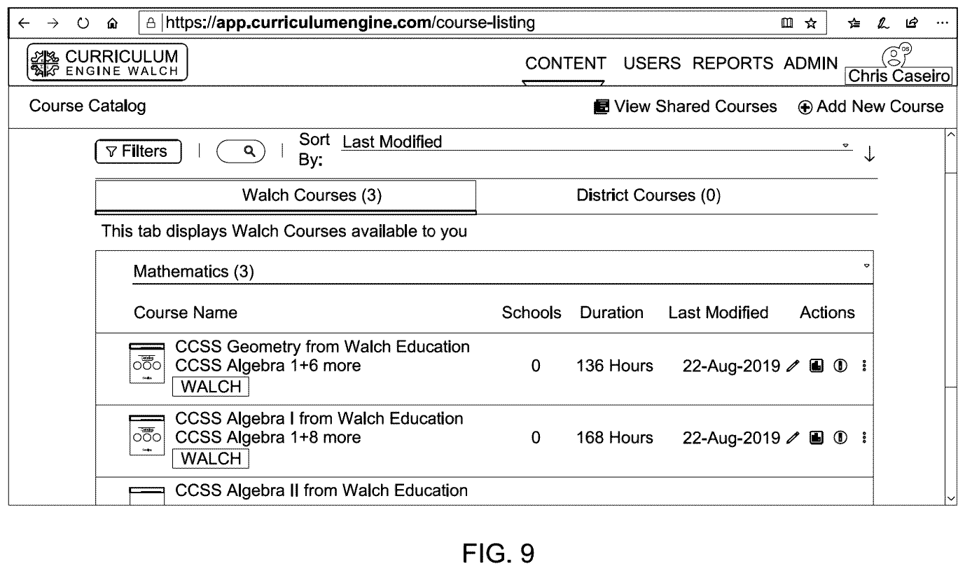

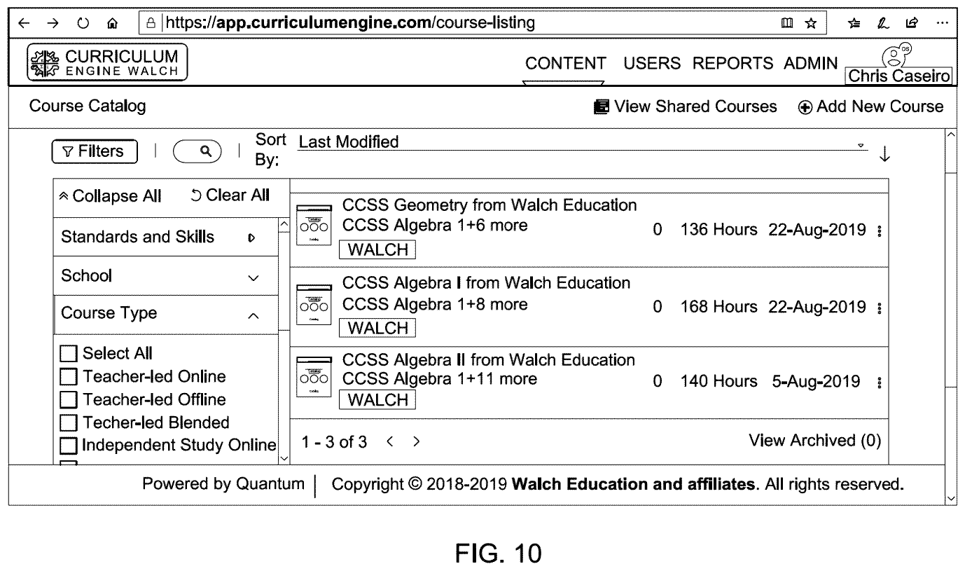

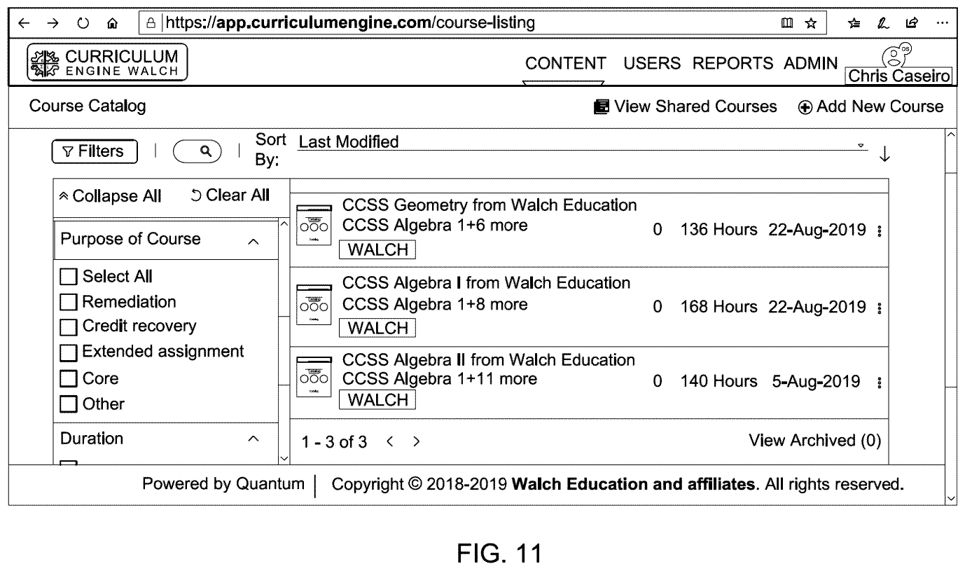

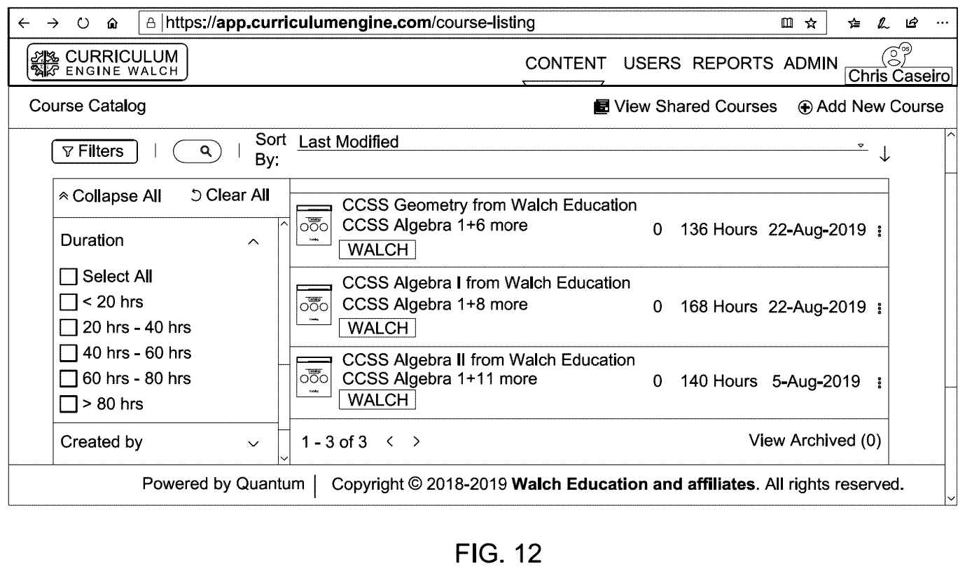

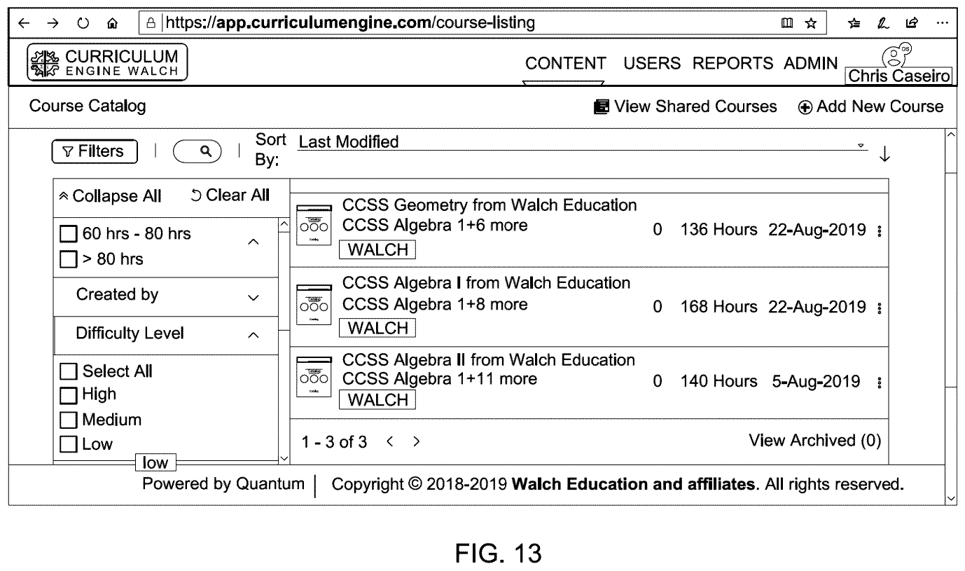

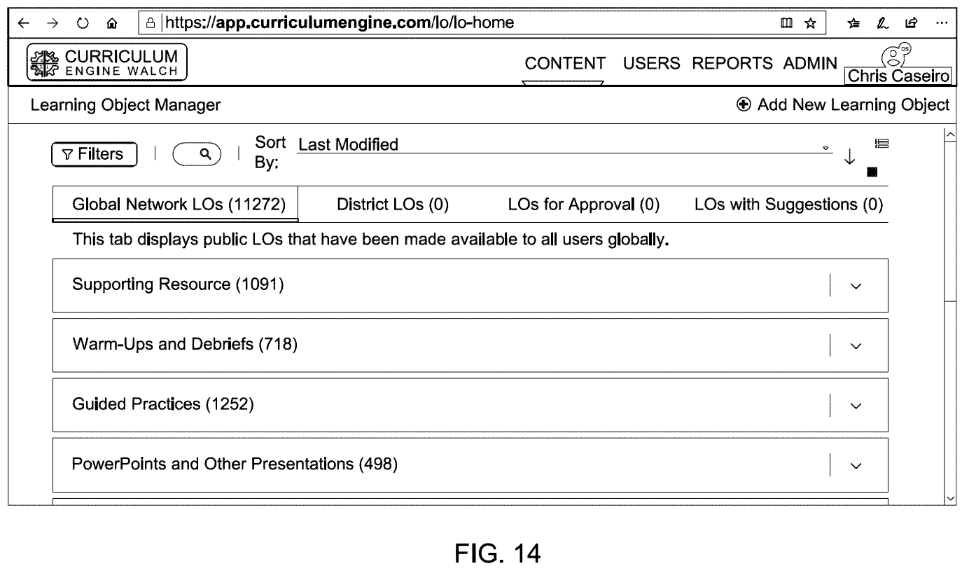

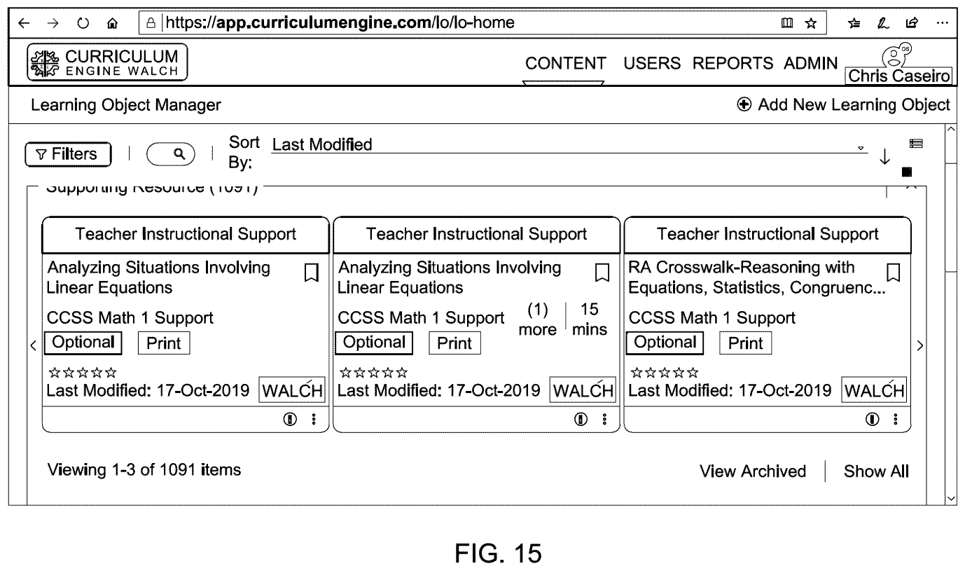

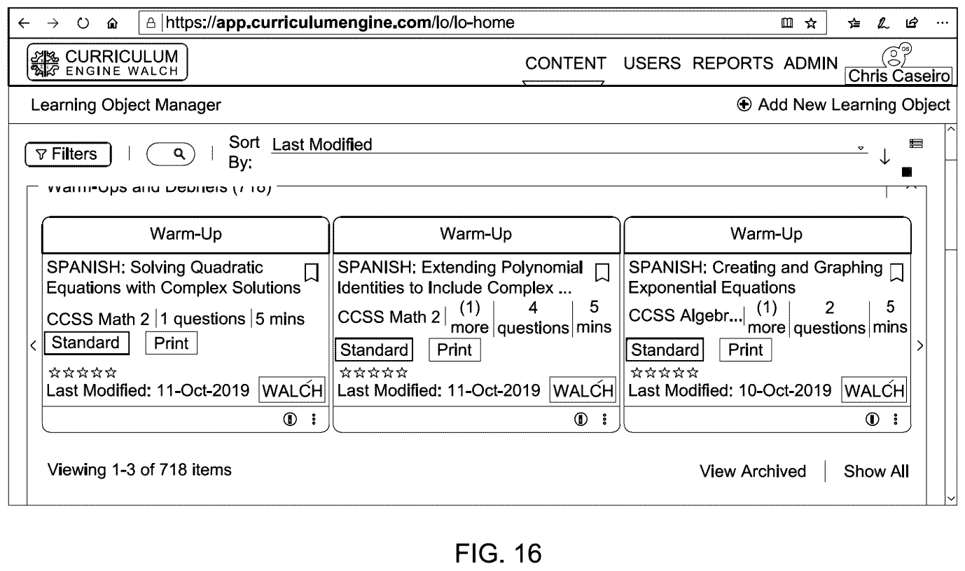

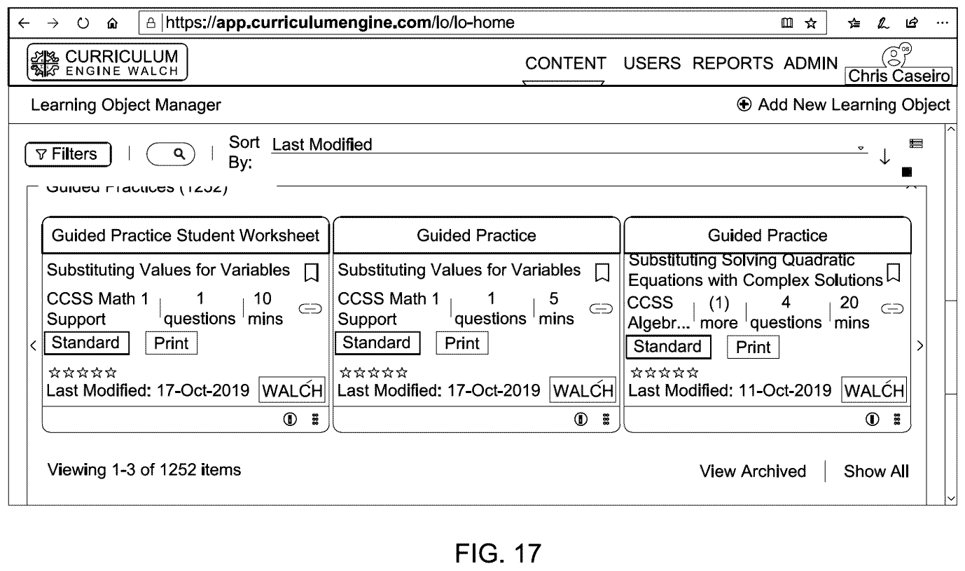

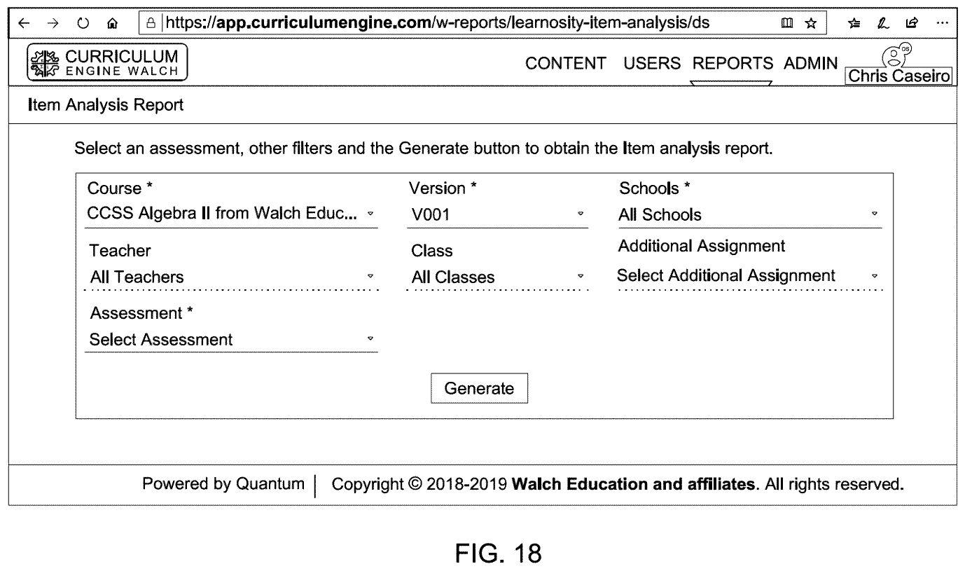

A simplified representation of certain user interfaces of the system 10 can be seen through FIGS. 9-18, in which a user can gain access to the system 10 through a computing device of choice including, but not limited to, a desktop computer, a laptop computer and a computer tablet. The user observes a user interface that includes dropdown menus, course availability links, and course content links. The user selects a course from the set available and/or can set parameters of type of course content to be provided and can observe course content available. The user can drill down to specific instructional objects and access those objects, such as teacher instructional support objects, warm-up objects and guided practice objects. Another user interface enables access to analysis of effectiveness of instructional objects employed.

The present invention has been described with respect to specific example embodiments but is not intended to be limited thereto. The scope of the invention is defined by the appended claims and reasonable equivalents.

What is claimed is:

1. A computer-implemented system configured to improve the operation of a computing device to enable a user in a school district to edit, author, and implement educational curricula and associated coursework that are compliant with government-established course curricula standards, such as state and local government standards but not limited thereto, the system comprising:
a computing device arranged for access to the internet and having stored thereon computer-executable instructions configured to cause the computer device to implement instructions;
an instructional object repository accessible through the computing device,
wherein content, vetted and enhanced with specific-purpose meta data as described herein, of the instructional object repository includes instructional objects;
an instructional object organization function configured to associate the instructional objects in the instructional object repository with metadata arranged to enable access of particular instructional objects and compile those selected instructional objects into the courses that include the associated coursework, wherein the courses may be modified by changing course specifications consistent with defined course standards and parameters, which result in changes in the organization of the instructional objects applied to those modified courses;
a tool and template configuration function configured to enable a user to generate sequences of delivery of the instructional objects of the instructional object repository that align with the government-established course curricula standards for the courses, including but not limited to sequencing, particularly for courses requiring the completion of prerequisites, wherein the tool and template function is further configured to enable a user to modify instructional components of the courses only to the extent that such modified instructional components do not deviate from the government-established course curricula standards, wherein the tool and template configuration function is also configured to alert the user when one when or more instructional components of a recommended course curriculum are included or not included in a way that fails to align the course with the government-established course curricula standards; and
an analytical engine configured to track and evaluate instructional content used in a school district to identify gaps in resultant outcomes used to implement changes in course materials.

2. The system of claim 1 further comprising a content identification and parsing into instructional objects function configured to gather materials associated with course curricula and parse the materials into the instructional objects.

3. The system of claim 1 wherein the instructional objects include text, tests, videos, and interactive worksheets.

4. The system of claim 3 wherein the instructional objects may be acquired from commercially available resources, privately developed materials, and publicly developed materials.

5. The system of claim 1 wherein the instructional object organization function is further configured to gather and organize instructional objects to generate course materials compliant with a selected established educational standard.

6. The system of claim 1 wherein the instructional objects include content associated with teaching courses in mathematics.

7. The system of claim 1 wherein the data gathering and analysis function is further configured to alert a user of the system when modifications to the complete course content fall outside of a selected established educational standard.

8. The system of claim 1 wherein the instructional object organization function is further configured to enable implementation of complete course content based on one or more metadata tags defined by the user.
